(19) United States
(12) Patent Application Publication
(10) Pub. No.: US 2011/0167831 A1
(43) Pub. Date: Jul. 14, 2011

(54) ADAPTIVE CORE ENGINE

(76) Inventor: JAMES EDWARD JOHNSON, Cincinnati, OH (US)

(21) Appl. No.: 12/871,048

(22) Filed: Aug. 30, 2010

Related U.S. Application Data
(60) Provisional application No. 61/246,078, filed on Sep. 25, 2009.
(60) Provisional application No. 61/247,752, filed on Oct. 1, 2009.

(51) Int. Cl. F02C 9/00; F02C 3/10; F04D 29/56

(52) U.S. Cl. 60/773; 60/792; 415/148

(57) ABSTRACT

A gas turbine engine having an adaptive core capable of maintaining a substantially constant core pressure ratio while having a variable flow rate is disclosed. In one aspect, the adaptive core comprises a front block compressor and a rear block compressor.

### CROSS-REFERENCE TO RELATED APPLICATIONS

This application claims priority to U.S. Provisional Application Ser. No. 61/246,078, filed Sep. 25, 2009, and U.S. Provisional Application Ser. No. 61/247,752, filed Oct. 1, 2009 which are herein incorporated by reference in their entirety.

### BACKGROUND OF THE INVENTION

This invention relates generally to jet propulsion engines, and more specifically to adaptive core engines capable of operating under variable flow conditions while maintaining near constant pressure ratios

Future mixed mission morphing aircraft as well as more conventional mixed mission capable military systems that have a high value of take-off thrust/take-off gross weight (i.e., a thrust loading in the 0.8-1.2 category), present many challenges to the propulsion system. They need efficient propulsion operation at diverse flight speeds, altitudes, and particularly at low power settings where conventional engines operate at inefficient off-design conditions both in terms of uninstalled performance and, to an even greater degree, fully installed performance that includes the impact of spillage drag losses associated with supersonic inlets.

When defining a conventional engine cycle and configuration for a mixed mission application, compromises have to be made in the selection of fan pressure ratio, bypass ratio, and overall pressure ratio to allow a reasonably sized engine to operate effectively at both subsonic and supersonic flight conditions. In particular, the fan pressure ratio and related bypass ratio selection needed to obtain a reasonably sized engine capable of developing the thrusts needed for combat maneuvers and supersonic operation are non-optimum for efficient low power subsonic flight. Basic uninstalled subsonic engine performance is compromised and fully installed performance suffers even more due to the inlet/engine flow mismatch that occurs at reduced power settings.

In the art, the core concepts used in convertible engines are quite complex, having multiple cores with complex ducting and valving needs. Current conventionally bladed core concepts cannot maintain constant or near constant operating pressure ratios as core flow is reduced. This severely limits the potential Specific Fuel Consumption (SFC) advantage offered by known variable bypass convertible engine concepts.

Accordingly, it would be desirable to have an adaptive core engine having a simpler core design having more traditional framing, sealing, and bearing needs while retaining the variable flow, near-constant pressure ratio operating potentials. It would be desirable to have methods of operating adaptive core engines that can operate under conditions of variable flows and pressure ratios while providing the SFC advantages over various flight regimes. It would be desirable to have convertible engines having adaptive cores that combine the advantages of convertible engines to lower SFC.

### BRIEF DESCRIPTION OF THE INVENTION

The above-mentioned need or needs may be met by exemplary embodiments disclosed herein which provide a gas turbine engine having an adaptive core capable of maintaining a substantially constant core pressure ratio while having a variable flow rate. In one aspect, an adaptive core comprises a front block compressor and a rear block compressor. In one embodiment, an adaptive core comprises a rear block compressor that is an axial flow compressor. In another embodiment, an adaptive core comprises a rear block compressor that has a centrifugal flow compressor.

Exemplary methods of operating a gas turbine engine are disclosed wherein an adaptive core is operated such that a substantially constant core pressure ratio is maintained while having a variable flow rate. In one embodiment, a method of operating an adaptive core includes operating a convertible fan.

### BRIEF DESCRIPTION OF THE DRAWINGS

The subject matter which is regarded as the invention is particularly pointed out and distinctly claimed in the concluding part of the specification. The invention, however, may be best understood by reference to the following description taken in conjunction with the accompanying drawing figures in which:

FIG. 1 is a schematic cross-sectional view of a portion of an adaptive core gas turbine engine constructed according to an aspect of the present invention.

FIG. 2 is an exemplary compressor map during operation of the exemplary adaptive core gas turbine engine shown in FIG. 1.

FIG. 3 is an example of the compressor operating characteristics of the exemplary adaptive core gas turbine engine shown in FIG. 1.

FIG. 4 is a schematic cross-sectional view of a convertible gas turbine engine constructed according to an aspect of the present invention.

FIG. 5 is a schematic cross-sectional view of a portion of an adaptive core gas turbine engine having a core fan constructed according to another aspect of the present invention.

FIG. 6 is a schematic cross-sectional view of a portion of an adaptive core gas turbine engine constructed according to another embodiment of the present invention having an axi-centrifugal rear block compressor.

FIG. 7 is a schematic cross-sectional view of another embodiment of the present invention of a convertible engine having an adaptive core having an axi-centrifugal rear block compressor.

FIG. 8 is a schematic cross-sectional view of another embodiment of the present invention of a convertible engine having a fladed fan and an adaptive core.

FIG. 9 is an example of the operating performance characteristics of a convertible engine having an adaptive core according to an exemplary embodiment of the present invention.

### DETAILED DESCRIPTION OF THE INVENTION

Referring to the drawings wherein identical reference numerals denote the same elements throughout the various views, FIG. 1 is a schematic cross-sectional view of a portion of an adaptive core gas turbine engine constructed according to an aspect of the present invention. The exemplary adaptive core gas turbine engine 10 shown in FIG. 1 comprises an adaptive core 20 having a front block compressor 30 and a rear block compressor 40. The front block compressor 30 comprises one or more compressor stages, each stage having a row of blades 36 arranged circumferentially around an engine center line axis 11. The row of blades 36 is suitably supported by a disk 34 or spool. A row of vanes 38 is located axially forward from the row of rotor blades 36. A row of vanes 134, often referred to as Inlet Guide vanes (IGV) 132 is located axially forward from the first rotor stage 130 of the front block compressor 30. The IGV 132 of the front block compressor 30 is a variable type, as shown schematically in FIG. 1. Other stator vanes 38 of the front block compressor 30 may also be variable stators, as shown schematically in FIG. 1. Variable stators allow variations in the basic flow of air and its direction through the compressor stages. The inlet guide vanes (IGV) 132 may have their angle of attack with respect to the airflow and their open flow area selectively changed by using an actuator 133. Suitable, known actuators can be used for this purpose. Optionally, some of the inter-stage vanes 38 may have their angle of attack with respect to the airflow and their open flow area selectively changed by using an actuator 39. Here again, suitable, known actuators can be used for this purpose

The adaptive core 20 shown schematically in FIG. 1 comprises a rear block compressor 40. In the exemplary embodiment shown in FIG. 1, the rear block compressor 40 is an axial compressor, comprising of one or more stages, each stage having a row of blades 46 arranged circumferentially around the engine center line axis 11. The row of blades is suitably supported by a disk or spool 44. A row of vanes 48 is located axially forward from the row of rotor blades 46. A row vanes, often referred to as rear block Inlet Guide vanes (IGV) 142 is located axially forward from the first rotor stage 140 of the rear block compressor 40. The rear block IGV 142 of the rear block compressor 40 is a variable type, as shown schematically in FIG. 1. Other stator vanes of the rear block compressor 40 may also be variable stators (not shown in FIG. 1). Variable stators allow variations in the basic flow of air and its direction through the compressor stages. In the rear block compressor 40, the inlet guide vanes (IGV) may have their angle of attack with respect to the airflow and their open flow area selectively changed by using a known actuator 143. Optionally, the interstage vanes may have their angle of attack with respect to the airflow and their open flow area selectively changed by using an actuator of a known type (not shown in FIG. 1). During operation, it is possible to move at least a portion of the rear block IGV 142 using the actuator 143 such that the flow of air into the rear block compressor 40 may be substantially blocked, except for some purge air flow (item 122 for example). The rear block 40 is “stowable” in that it is capable of being substantially fully closed using the IGV system 142 and actuator 143 to prevent airflow through it, except for a purge flow 122. In the exemplary embodiment shown in FIG. 1, the front block compressor 30 and the rear block compressor 40 are driven by a high pressure turbine 60 that is coupled to a turbine shaft 42 that in turn is coupled to a compressor shaft. The

Although FIG. 1 shows an axial flow compressor for the rear block compressor 40, in alternative embodiments of the present invention, the rear block compressor may be a centrifugal compressor or an axi-centrifugal compressor, such as, for example, shown as items 352, 252, 376 in FIGS. 6-8.

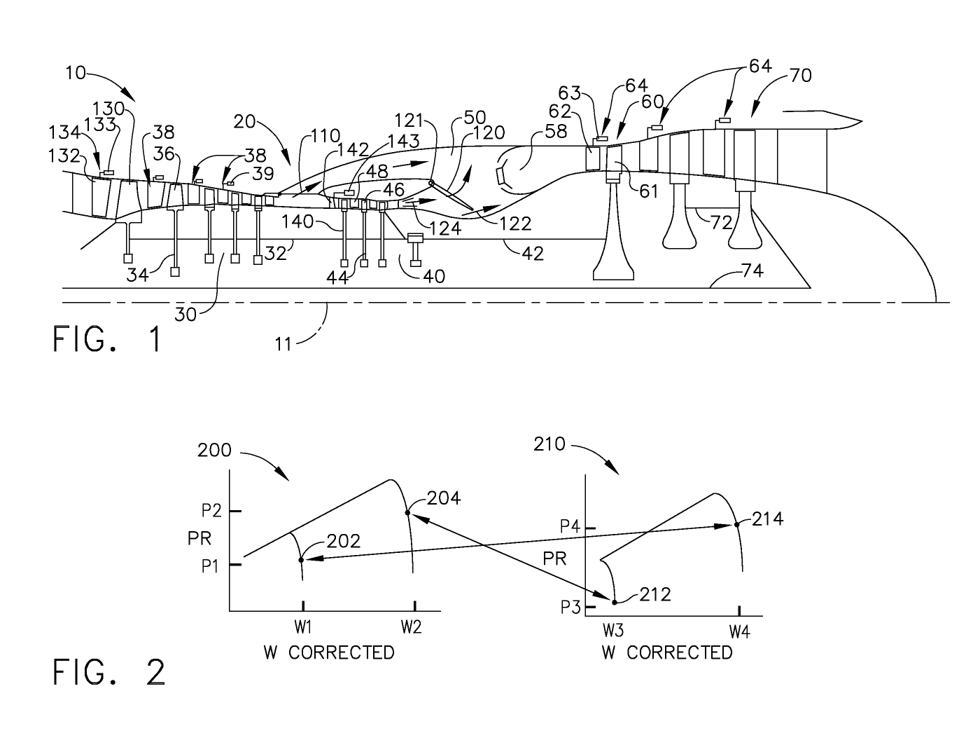

During operation of the adaptive core engines, such as for example shown in the figures herein, at the maximum flow operation condition, the front block compressor 30 (see FIG. 1) is operated at design speed and pressure ratio while the front block compressor IGV 132 is kept substantially fully open. This is schematically shown in FIG. 2. FIG. 2 is an exemplary compressor map during operation of the exemplary adaptive core gas turbine engine, such as, for example, shown in FIG. 1. Referring to FIG. 2, for this example the front block pressure ratio (“PR”) is set at a value of P2 (8.5 for example), and the reference compressor flow rate (“W2”) is at about 100% (see item 204, FIG. 2). The rear block IGV 142 is substantially closed (see item 212, FIG. 2) with only a controlled purge flow 122 passing through this section of the rear block compressor 40.

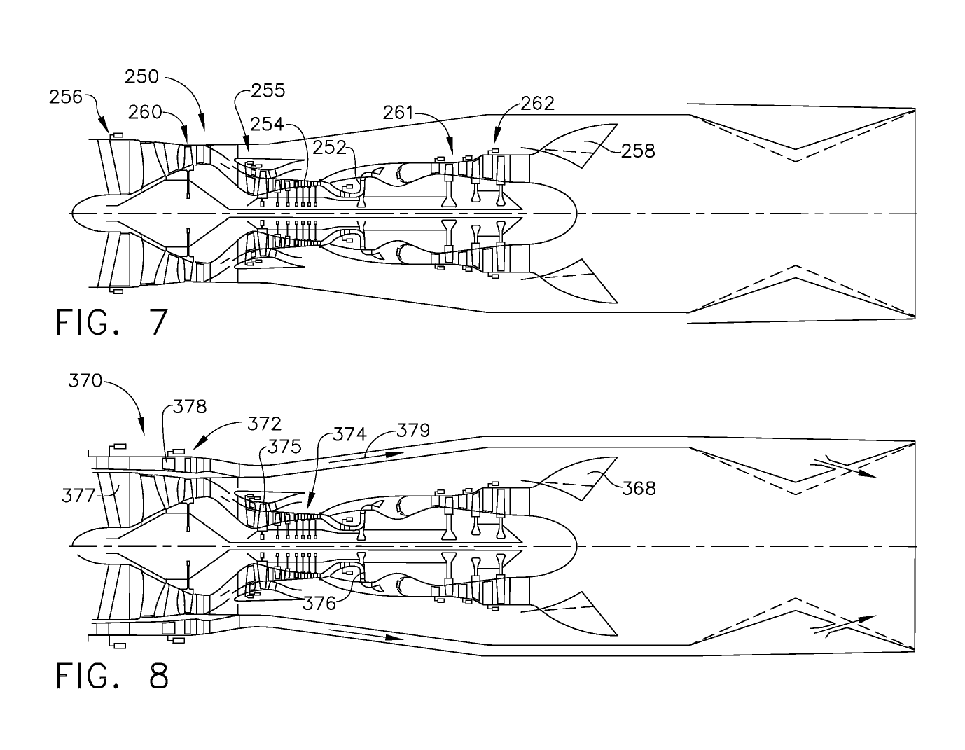

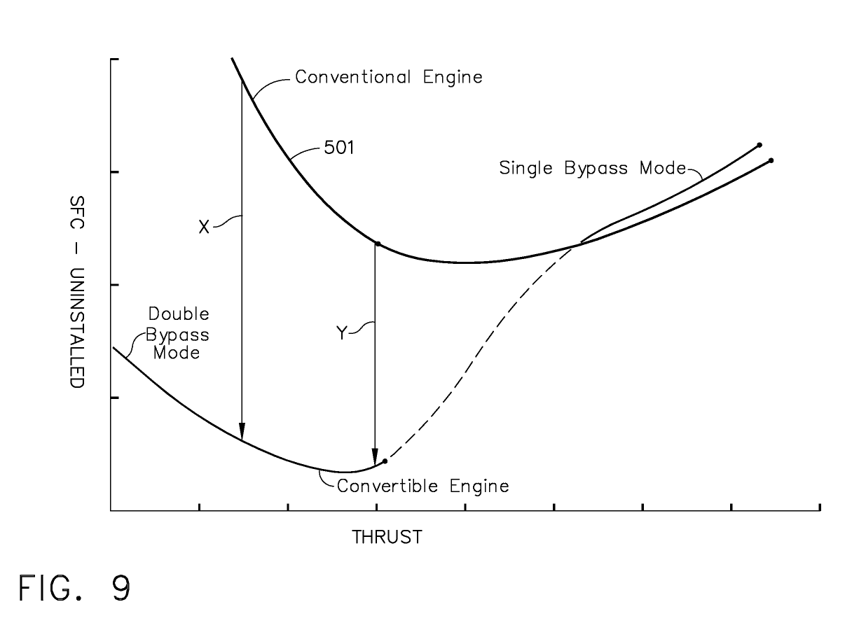

In this mode of operation (i.e., maximum flow condition) the majority of the front block compressor flow 110 goes around the rear block compressor 40 and goes through a controlled area diffuser 50 before entering the combustor 58. An exemplary variable area diffuser shown in FIG. 1 comprises a baffle 120 that is operable around a hinge 121 to control the diffusion of the flow from the compressors 30, 40. See FIG. 1. Other suitable methods can be alternatively used to control the diffusion of the flow. The adaptive core engine comprises a high pressure turbine (HPT) 60. The HPT comprises a HPT vanes 62 that are located axially forward from the HP turbine blades 61. In the exemplary embodiment shown in FIG. 1, the HPT vanes 62 (alternatively referred to herein as nozzles) are the variable area type (VATN), such that the flow geometry may be varied using known actuators 63 during operation of the engine 10. In the exemplary embodiment shown in FIG. 1 and the operation described in FIG. 2, the HP turbine vanes are in their full open position during the maximum compressor flow operation. For reduced thrust, variable bypass operation in a convertible engine (see FIGS. 7 and 8 for example) the front block flow is reduced by partially closing IGV 132 and other front block compressor variable stators 38 with a minimum amount of rotor speed (rpm) reduction. This combination keeps the rear block compressor 40 speed high for maximizing its pressure ratio potential during reduced flow operation of the front block compressor 30. Also, to help produce a high pressure ratio in the rear block compressor 40, the rear block compressor 40 design corrected speed is based on the super-charging temperature of the front block compressor discharge when the front block compressor is operated at a reduced pressure ratio level. In the exemplary method of operating shown in FIG. 2, the front block compressor 30 is at pressure ratio of “P1” (4.7 for example) at an operating corrected flow of “W1” % (60% for example). With a rear block compressor 40 design pressure ratio of “P4” (1.8 for example), and it's IGV 142 substantially fully open (see item 214, FIG. 2), the front block compressor flow now goes through the rear block compressor (see item 124 in FIG. 1) producing an overall core pressure ratio of close to “P2” (4.7×1.7=8.5 in the example) at a corrected flow of “W1” (60% in the example). The variable HPT vanes 62 may partially close for this operating mode of having substantially constant pressure ratio while having variable flow.

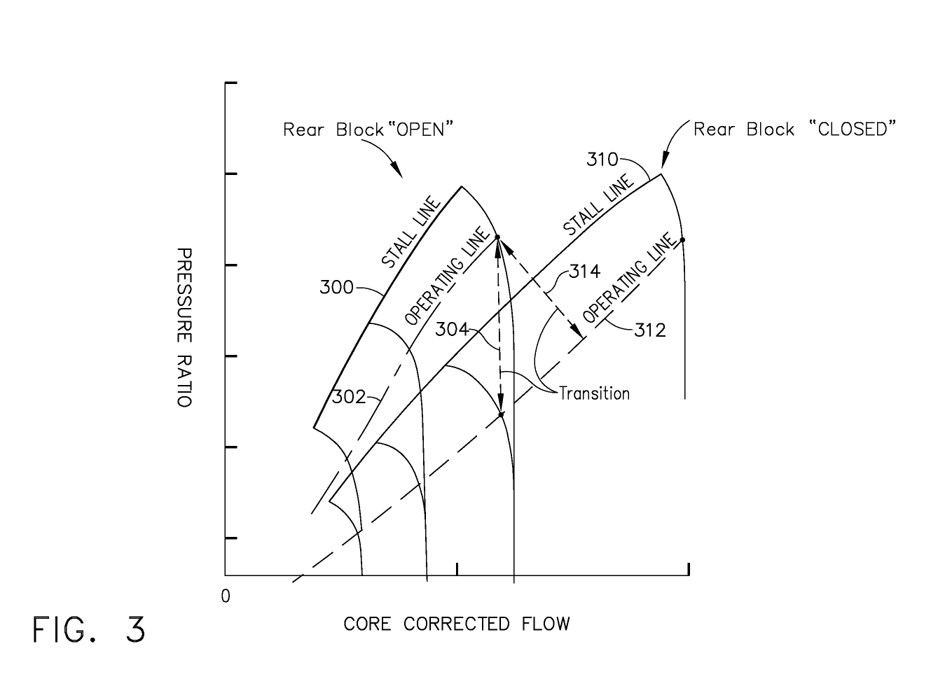

FIG. 3 shows an example of the operating characteristics of the exemplary adaptive core 20 compressor in the exemplary adaptive core gas turbine engine 10 shown in FIG. 1. FIG. 3 illustrates the unique type of compressor map/operation that results from two-block core compression systems shown in the exemplary embodiments shown herein. FIG. 3 shows the adaptive core characteristics of corrected flow vs. pressure ratio, with the Rear block compressor “open” and with the Rear block compressor “closed”. The operating lines 302, 312 and stall lines 300, 310 shift as shown in FIG. 3, having transition lines 304 shown for example.

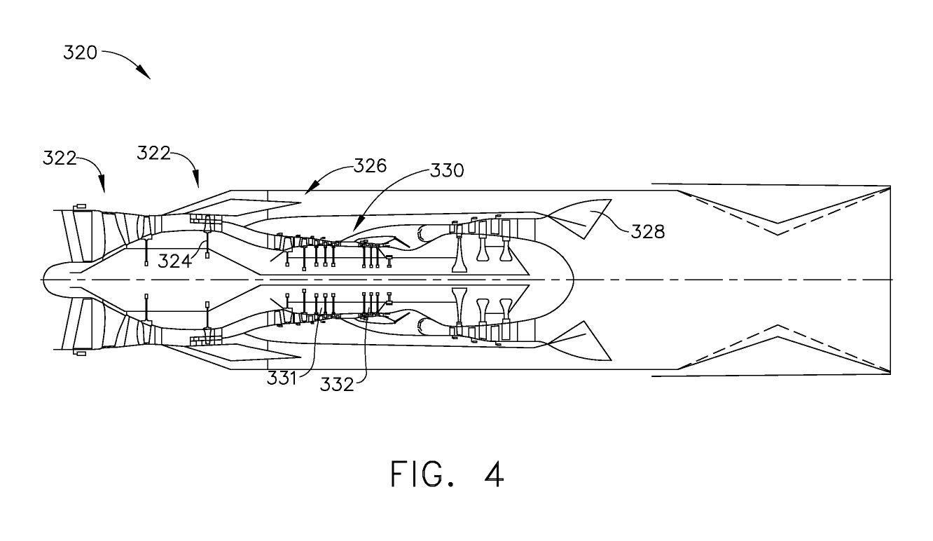

FIG. 4 shows a schematic cross-sectional view of a convertible gas turbine engine 320 constructed according to an aspect of the present invention. A “convertible” gas turbine engine comprises a “Convertible” fan, such as described in the co-pending non-provisional U.S. patent application Ser. No. 11/617,371, filed Dec. 28, 2006, entitled “Convertible Gas Turbine Engine”, and is incorporated herein by reference in its entirety. FIG. 4 shows schematically a convertible gas turbine engine 320 having an adaptive core 330 and a convertible fan system 322. The gas turbine engine 320 comprises a substantially constant flow-variable pressure ratio convertible fan system 322. The exemplary embodiment of the convertible fan system 322 shown in FIG. 4 comprises a tri-pass splitterd rotor 324 and segmented IGV's for optimized supercharge. FIG. 4 also shows a double by-pass 326 and a variable area mixer 328 that mixes the core flow and bypass flows in the engine 320. The convertible engine 320 shown in FIG. 4 comprises an adaptive core 330 that has a front block compressor 331 and a rear block compressor 332 that are similar to the embodiment shown in FIG. 1 and described previously.

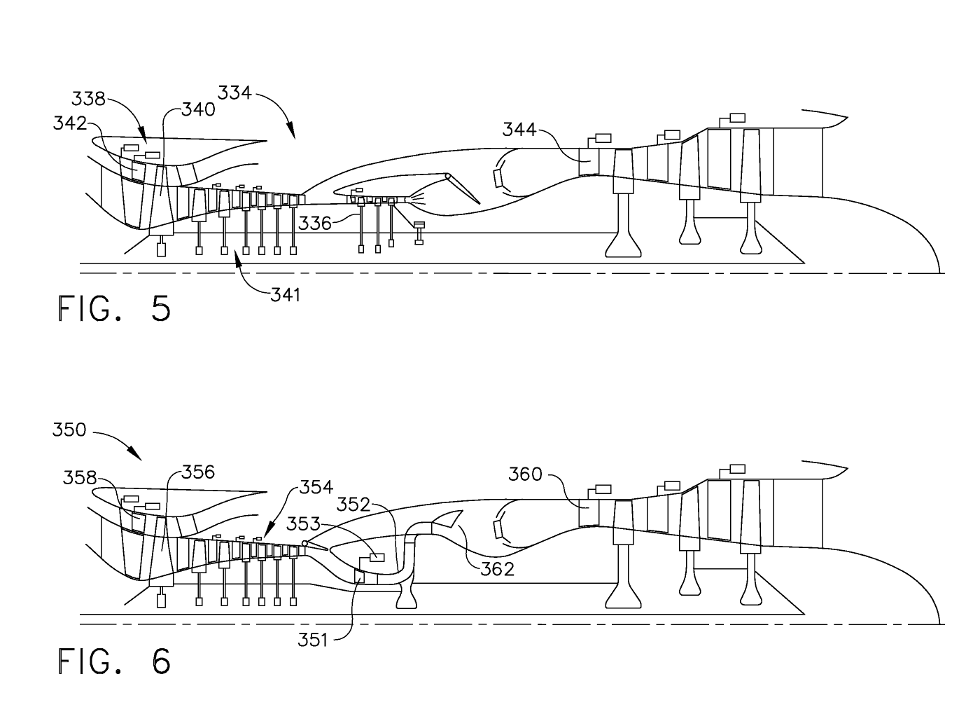

In another embodiment of the present invention, FIG. 5 shows a schematic cross-sectional view of a portion of an adaptive core gas turbine engine 334 having a core fan 338 (a fan driven by the same turbine that drives the core compressors) coupled to the front block compressor 341 that is coupled to a rear block compressor 336. In the exemplary embodiment shown in FIG. 5, the core fan 338 comprises a flade 340. A suitable flade known in the art may be used. The engine system 334 may also include variable vane 342 to vary the amount of flow into the flade 340 and its direction. The engine system 334 may also a variable turbine nozzle 344 such as, for example, shown schematically in FIG. 5.

In the exemplary embodiments shown in FIGS. 1, 4 and 5, the rear block compressor is shown, for example, as an axial flow compressor. However, the rear block compressor may be of other suitable types, such as, for example, shown in FIGS. 6-8. FIG. 6 shows a schematic cross-sectional view of a portion of an adaptive core gas turbine engine 350 constructed according to another embodiment of the present invention having an axi-centrifugal rear block compressor 352. In the exemplary engine 350 shown, the front block compressor 354 is an axial flow compressor, similar to the front block compressor 30 shown in FIG. 1 and described previously herein. In the exemplary engine 350 shown, the rear block compressor 352 comprises a centrifugal compressor that offers a less complex controlled area diffuser/mixer 362 design. Air enters the rear block compressor 352 in the axial direction. A rear block IGV 351 is located axially forward from the rear block compressor 352. The rear block IGV 351 is a variable type to change the flow area, as shown schematically in FIG. 6. During operation, it is possible to move at least a portion of the rear block IGV 351 using an actuator 353 such that the flow of air into the rear block compressor 352 may be substantially blocked. In the exemplary embodiment shown in FIG. 6, the core fan comprises a flade 356. A suitable flade known in the art may be used. The engine system 350 may also include variable vane 358 to vary the amount of flow into the flade 356 and its direction. The engine system 350 may also a variable turbine nozzle 360 such as, for example, shown schematically in FIG. 6. A row vanes, often referred to as rear block Inlet Guide vanes (IGV) 142 is located axially forward from the first rotor stage 140 of the rear block compressor 40. During operation, it is possible to move at least a portion of the rear block IGV 142 using the actuator 143 such that the flow of air into the rear block compressor 40 may be substantially blocked. The operation of the front block compressor 354 and the rear block compressor 352 in the engine system 350 is similar to the operation of the front and rear block compressors in the engine system 10 shown in FIG. 1 and described previously herein.

FIG. 7 shows a schematic cross-sectional view of another embodiment of the present invention of a convertible engine 250 having an adaptive core. The convertible engine 250 has an axi-centrifugal rear block compressor 252 and an axial front block compressor 254, similar to the embodiment shown in FIG. 6 and described previously. The exemplary embodiment of the convertible engine 250 comprises a core fan system 255, similar to the embodiment shown in FIG. 6 and a variable area bypass injector (VABI) 258. The front block compressor 254, rear block compressor 252 and the core fan 255 are driven by a high pressure turbine (HPT) 261. The convertible engine 250 comprises a fan 260 that is driven by a low pressure turbine (LPT) 262. As shown schematically in FIG. 7, the HPT nozzle, located axially forward from the HPT blade may be a variable type to enhance the operation the engine 250. Similarly the LPT nozzle may be a variable type.

FIG. 8 shows a schematic cross-sectional view of another embodiment of the present invention of a convertible engine 370 having a fladed fan 372 and an adaptive core. The exemplary embodiment shown in FIG. 8 comprises an axial front block compressor 374, a centrifugal rear block compressor 376 and a core fan 375 similar to the embodiment shown in FIGS. 6 and 7 and described previously. The convertible engine 370 may optionally include a variable area bypass injector (VABI) 368 and variable vanes 377. The fladed fan 372 may be of a type known in the art. The fladed fan comprises a variable vane system 378 that can vary the amount of air flow and the direction of air flow entering the fladed fan. The flade fan stream air 379 flows in an outer duct and may be mixed with the core flow exit from exhaust nozzle, as shown in FIG. 8.

FIG. 9 shows an example of the operating performance characteristics of a convertible engine having an adaptive core according to the exemplary embodiments of the present invention described before. FIG. 9 illustrates schematically the differences in the operation of the engines having adaptive core as disclosed herein, as compared to a conventional gas turbine engine. When reduced power is required, for example for long-range cruising flight, the exemplary engines, such as disclosed herein, may be operated in “double bypass” mode, maintaining a constant total fan flow rate, reducing the fan overall pressure ratio in the bypass duct, maintaining a constant core pressure ratio and a constant overall pressure ratio, and increasing the bypass ratio. As shown in FIG. 9, the improvement in the Specific Fuel Consumption (SFC) in the low thrust operation modes of the convertible engine is significant, as marked by “X” and “Y”. For example, a max power mode setting can comprise a fan tip and hub pressure ratio of about 5.0, a core pressure ratio of about 8.5 (with an overall pressure ratio of 42) and a bypass ratio of about 0.77. A low power mode setting can comprise a fan tip pressure ratio of about 2.6, fan hub pressure ratio of about 5.0, core pressure ratio of about 8.5 (with an overall pressure ratio of 42) and a bypass ratio of about 1.98. Thus, in conjunction with a convertible fan, the adaptable core allows a bypass ratio variation between 0.77 to 1.98 while maintaining constant core operating pressure ratio and constant overall cycle pressure ratio.

FIG. 10 is a schematic cross-sectional view of another embodiment of the present invention of a convertible engine 390 having a variable geometry and an adaptive core 392 having a front block compressor 394 and a rear block compressor 396.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A gas turbine engine comprising:
an adaptive core capable of maintaining a substantially constant core pressure ratio while having a variable flow rate.

2. A gas turbine engine according to claim 1 wherein the adaptive core comprises a front block compressor and a rear block compressor.

3. A gas turbine engine according to claim 2 wherein the front block compressor is an axial compressor.

4. A gas turbine engine according to claim 2 wherein the rear block compressor is an axial compressor.

5. A gas turbine engine according to claim 2 wherein the rear block compressor is a centrifugal compressor.

6. A gas turbine engine according to claim 2 wherein the rear block compressor is a axial-centrifugal compressor.

7. A gas turbine engine according to claim 2 wherein the adaptive core comprises a variable area diffuser.

8. A gas turbine engine according to claim 2 wherein the rear block compressor comprises an inlet guide vane system capable of varying the flow into the rear block compressor.

9. A gas turbine engine according to claim 2 further comprising a convertible fan system.

10. A gas turbine engine according to claim 9 wherein the convertible fan system comprises a core fan.

11. A gas turbine engine according to claim 10 wherein the core fan comprises a flade.

12. A gas turbine engine according to claim 11 further comprising a variable vane located axially forward from the flade.

13. A gas turbine engine according to claim 2 further comprising a variable area turbine nozzle that is capable of varying the flow in a turbine.

14. A method of operating a gas turbine engine wherein an adaptive core is operated such that a substantially constant core pressure ratio is maintained while having a variable flow rate.

15. A method according to claim 14 wherein the substantially constant pressure ratio is maintained using a front block compressor and a rear block compressor.

16. A method according to claim 15 wherein the flow of air into the rear block compressor is substantially reduced during high power mode operation.

17. A method according to claim 15 wherein the flow of air into the rear block compressor is permitted during low power mode operation such that a selected core pressure is maintained.

18. A method according to claim 15 further comprising operating a convertible fan such that a double bypass mode is used in low power settings.

19. A method according to claim 18 wherein the convertible fan is operated such that a bypass ratio is varied while maintaining a substantially constant core pressure ratio.

20. A method according to claim 15 further comprising operating a flade system.
